(19) United States
(12) Patent Application Publication
(10) Pub. No.: US 2015/0115026 A1
(43) Pub. Date: Apr. 30, 2015

(54) Fluid Movement Tracking System, Especially Suitable for Water and Crude Oil Produced in Connection With Oil and Gas Well Operations

(71) Applicant: Thomas Gladulich, Lansdale, PA (US)

(72) Inventor: Thomas Gladulich, Lansdale, PA (US)

(21) Appl. No.: 14/522,829

(22) Filed: Oct. 24, 2014

Related U.S. Application Data
(60) Provisional application No. 61/895,045, filed on Oct. 24, 2013.

(51) Int. Cl. G06Q 10/08

(52) U.S. Cl. CPC G06Q 10/0833; G06Q 10/0832
USPC 235/376

(57) ABSTRACT

A fluid movement tracking system, enabling tracking of fluids moved between a pickup location and a disposal location by tank truck, utilizes identifiers, typically Quick Response or “QR” codes, mounted on fluid containers (commonly tanks) to provide information about fluid type, container capacity and location, etc. The QR codes are scanned by an optical reader on a handheld portable computing device, for example a tablet device, using a wireless mobile operating system such as the Android system. In addition to the QR code information, other information including but not limited to the fluid type, fluid volume, tank truck, the tank truck driver, are all entered. The information is received by a data process, CPU or computer via a wireless data transmission network, either by Wifi or cellular network, via appropriate software, and enters same into spreadsheets for tracking, billing, and other purposes.

### CROSS REFERENCE TO RELATED APPLICATIONS

This regular United States patent application claims priority to U.S. Provisional patent application Ser. No. 61/895,045, filed Oct. 24, 2013, for all purposes. The disclosure of that provisional patent application is incorporated herein to the extent that it is not inconsistent with the content of this application.

### BACKGROUND

Various fluids are flowed out of oil and gas wells, including “produced water,” namely salt water which flows from the well in association with produced oil and gas; and “flowback water,” which flows out of a well after operations such as hydraulic fracturing. Both types of water will be generally referred to herein as “produced water.”

Tremendous volumes of produced water are transferred everyday via trucks and pipeline in oilfield operations. Due to State and Federal regulations, Oil and Gas Operators are required to account for all water that goes into and flows out of every well. The reporting of water is required to be extremely accurate.

While some produced water is moved by pipeline, in many areas most or all of the produced water is moved by fluid transporters, namely tank trucks. When trucking water, personnel, namely truck drivers, normally fill out a paper water manifest or water ticket for each load of water (approximately 4,600 gallons per load, with at times up to 1300 loads per well) in order to keep track of the water being moved.

This paper manifest is crucial in keeping track of the movement of water, since all information needed to properly track water volumes is dependent upon the driver writing in the correct data onto the manifest. Several key factors are dependent upon these water manifests, including billing, inventory, and state/federal reporting. As a result, the information on every water manifest or ticket must be accounted for, and usually manually transferred from the manifest into a spreadsheet. Thousands of these water tickets are generated each month and have to be sorted and all information thereon entered into the spreadsheet. As can be appreciated, this is a very time consuming process, made worse by illegible handwriting, missing information, incorrect information, and human error in transposition of numbers, mis-entry of figures, etc.

In addition to produced water, produced crude oil is, in many areas, transported from the production site to another location by trucking Where crude oil is transported by truck in this manner, all of the same issues exist in connection with the tracking of the source of the produced oil (e.g. which well and/or lease(s)), its quantity and type, and delivery site, etc., as with produced water. Similarly, all of the limitations and issues described above in connection with the manual ticketing process, etc. for produced water, all apply to produced crude as well.

In this application, the terms “fluid” and “fluids” are used in a broad sense, and include both water (of any nature) and crude oil, both flowed from an oil and gas well, as well as other types of fluids, for example ground water stored in tanks or an earthen pond, etc.

### SUMMARY OF THE INVENTION

The present invention is a digital processor or computer-based, and barcode or Quick Response (“QR”) scanner-based system, with associated programming, along with QR codes physically placed on tanks and the like, in combination with a wireless data transmission system, for tracking movements of fluids, including but not limited to produced crude oil and produced water, from and between on-site storage tanks or any other fluid-holder, including for example earthen tanks and ponds, to tank trucks for road transport, and from the tank truck to a disposal facility or other disposition point.

All of such fluid-holding sources will be referred to generally herein as a “storage tank,” even though certain of them are not “tanks” as such, but other containers or reservoirs. Each fluid storage tank (or truck tank) has a bar code or Quick Response (“QR”) code fixed thereto, which identifies the tank number, location, capacity, and the company whose location they are on. In the case of fluids held in an earthen tank or pit or the like, the QR code may be fixed to a stake or pole proximal the pond. Both conventional barcodes, and newer QR codes, will be referred to generally as “QR codes.”

The QR code is scanned by personnel operating the fluid transporter, which may be a truck, using the optical reader of a portable computing device, which may be a digital “tablet” device, or similar device. Information regarding the fluid storage tank on which the QR code is mounted is stored in a central database (for example, location of the tank, capacity of the tank, etc.), which may be present or hosted on a digital processor or computer. This information is transmitted to the tablet via the wireless data transmission system. The only variables which are typically within the personnel's (truck driver's) control to confirm or change, if necessary, are the type of fluid being loaded and the volume. All other relevant information is contained in the central database of the digital processor, and is associated with the QR code, significantly cutting down on human error.

The information obtained from scanning the QR code is then stored in the tablet device, and when the tablet is WiFi capable (that is, comes within operative range of a WiFi network), the information or data is automatically uploaded to a server, namely the central database of the digital processor. When the tablet is on a cellular network (e.g., Verizon, AT&T), the data is uploaded to the server on a regular basis, for example every 30 seconds when cellular network service is in place. The information related to the fluid pickups and deliveries can then be exported into one or more spreadsheets, in a desired format, to permit the data to be utilized. The information is saved on the server and can be accessed by the customer through a website. The information can be sorted and viewed in various different ways, and can be used for billing purposes.

As can be understood, this system and method embodying the principles of the present invention comprises appropriate computer programming, digital processors, etc. to enable its proper function. Preferably, a mobile operating system such as the Android operating system is used, which provides a user interface on the portable computing device (tablet) enabling direct manipulation, for example a touchscreen, as is in common use.

### BRIEF DESCRIPTION OF THE FIGURES

FIG. 1 is a view of a fluid tank, showing a QR code tag mounted thereon, along with a fluid transporter (tank truck) proximal thereto and receiving fluids.

FIG. 2 is a view of the screen of a portable computing device, for example a tablet device, showing one arrangement of a touch screen interface and command “buttons.”

FIG. 3 is a view of the screen of a portable computing device, for example a tablet device, showing one arrangement of a touch screen interface and Start Details Display Screen, along with an entry or “confirm” button.

FIG. 4 shows an exemplary QR code, and personnel scanning the QR code mounted on a tank with the optical reader on a portable computing device (tablet).

FIG. 5 is a view of the screen of a portable computing device, for example a tablet device, showing one arrangement of a touch screen interface and a Scan Pickup Display Screen, along with an entry or “confirm” button.

FIG. 6 is a view of the screen of a portable computing device, for example a tablet device, showing one arrangement of a touch screen interface and Transportation Log information shown thereon.

FIG. 7 is a view of an exemplary client interface website, compiled from information obtained and transmitted by the system of the present invention.

FIG. 8 is a view of an exemplary Daily Transport Records page, showing fluid movement information for a given date.

FIGS. 9-11 are views of exemplary reports generated by the system of the present invention, showing fluid movement information sorted by various variables.

FIG. 12 is a schematic of the various components of an embodiment of the system, according to the teachings of the present invention, illustrating a WiFi-enabled personal computing device (tablet) and information exchange via WiFi and an associated network to the central digital processor or computer.

FIG. 13 is a schematic of the various components of an embodiment of the system, according to the teachings of the present invention, illustrating a cellular network-enabled personal computing device (tablet) and information exchange via said network to the central digital processor or computer.

FIG. 14 is a flow diagram showing exemplary steps of a method embodying the principles of the present invention.

FIG. 15 shows a tank truck off loading a load of fluid at a disposal site, with a QR code at the site being scanned by a portable computing device.

### DESCRIPTION OF A SYSTEM EMBODYING THE PRINCIPLES OF THE PRESENT INVENTION

While various changes may be made to form different embodiments of the present invention, by way of illustration and not limitation a system and method(s) of use of same, embodying the principles of the present invention, can be described in connection with the various figures.

### Initial Steps; Placement of QR Code Tags and Entry of Related Information

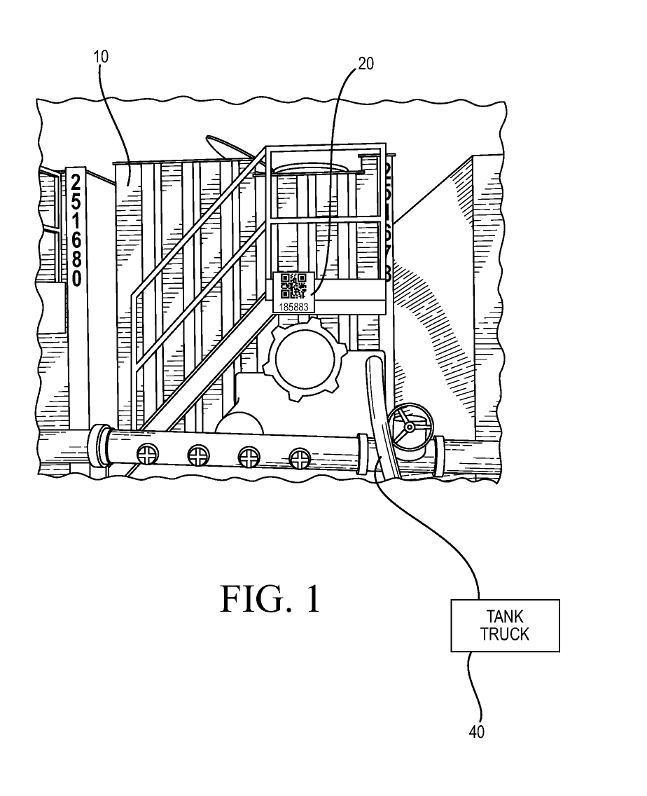

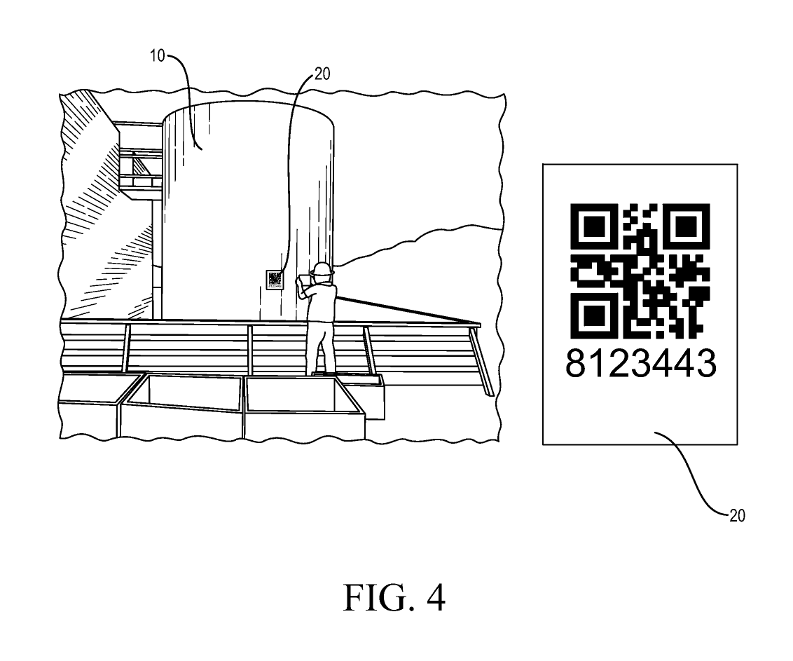

QR code tags, plaques, etc. are available for purchase in a hardcopy form, for example a metal or other durable sheet material on which is painted or otherwise inscribed the actual QR code. These QR code tags can be purchased in bulk. In connection with the system of the present invention, a company or individual, typically a representative of an oil and gas production company, will purchase a supply of QR code tags for installation on fluid tanks, and install same. As mentioned before herein, the QR tag may be mounted on a tank or other physical structure, placed on a post, etc. by a pond or the like, or other suitable placement. All of such fluid containers, including those traditionally known as tanks, but also ponds, etc. are all referred to herein as “tanks.” FIGS. 1 and 4 show QR tags 20 mounted on fluid tanks 10 of different sorts.

Once the QR tag is mounted, the representative will use the optical reader or scanner of a portable computing device, commonly called a “tablet,” in conjunction with a suitable application, to scan the QR code onto the tablet device (described further below in connection with FIG. 4). The representative will assign relevant information to be associated with that particular QR code; for example, the name of the company, site name, fluid tank name, GPS coordinates, and the type of fluid that is primarily associated with that fluid tank, and hence that QR code.

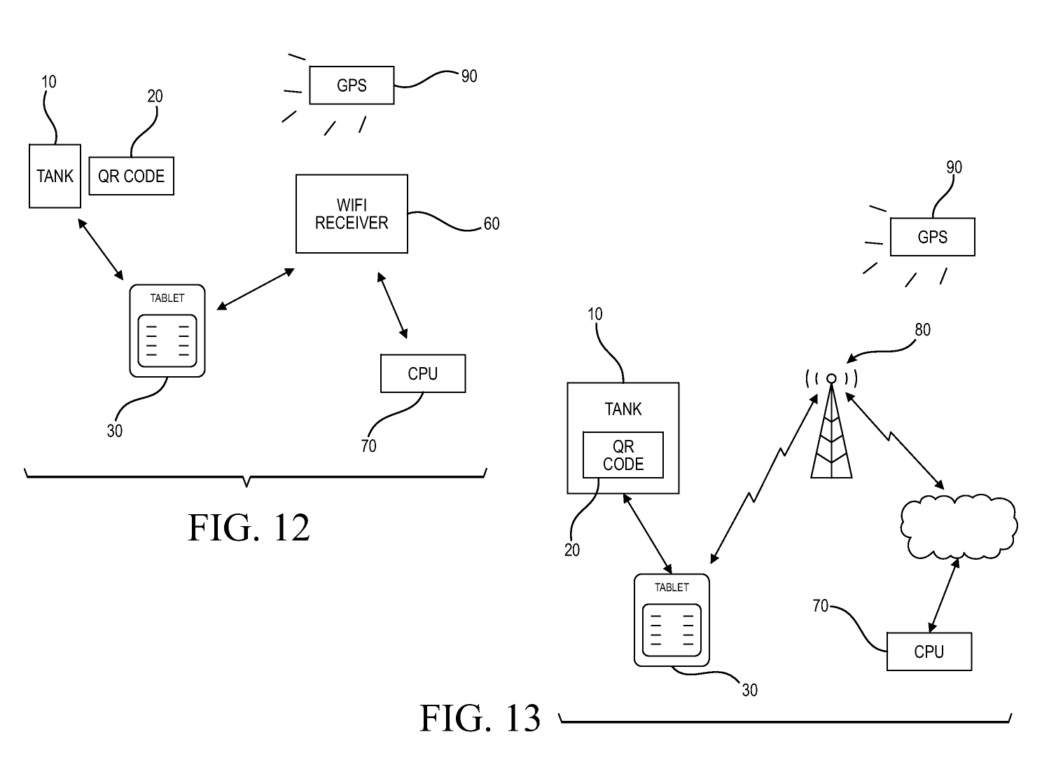

This fluid tank-related information is then transmitted (commonly referred to as synchronized, or “synced”) via a wireless data transmission system to a database on a digital processor or computer (CPU), as can be understood from FIGS. 12 and 13. Further description of possible wireless data transmission systems is given below. In turn, the wireless data transmission system then transmits the data associated with a given QR code to all portable computing devices, or tablets, in a desired work group. In doing this, when the QR code is scanned, the QR code will serve as an identifier populating the information that was previously designated to that QR code. This takes away the human error of personnel inadvertently making errors in entering location and tank information.

### Implementing the System

Once QR codes are placed at all locations where fluid is stored (in preparation for pickup and delivery), the system is ready to use. A typical sequence can now be described, in the setting of personnel typically in the capacity of the driver of a fluids transporter, which may be a fluid tank truck, who may be referred to as the “driver,” going through the usual routine of fluid pickup, transport to another location, and delivery thereto. As noted above, the fluid may be produced water, produced crude oil, or any other type of fluid.

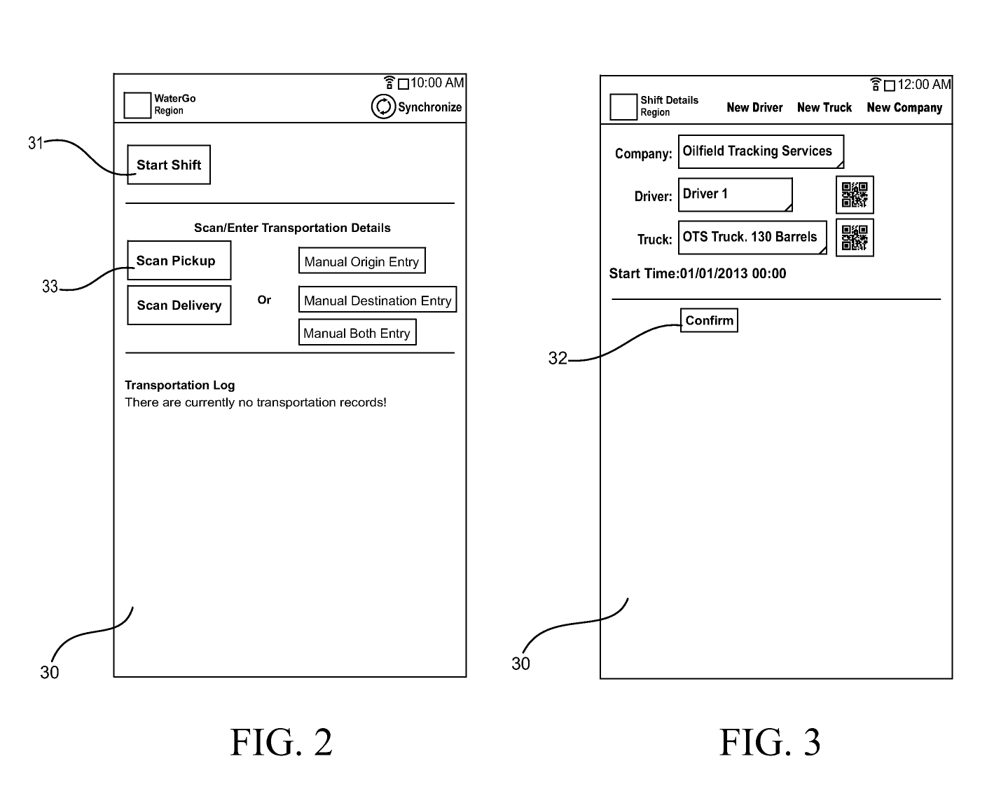

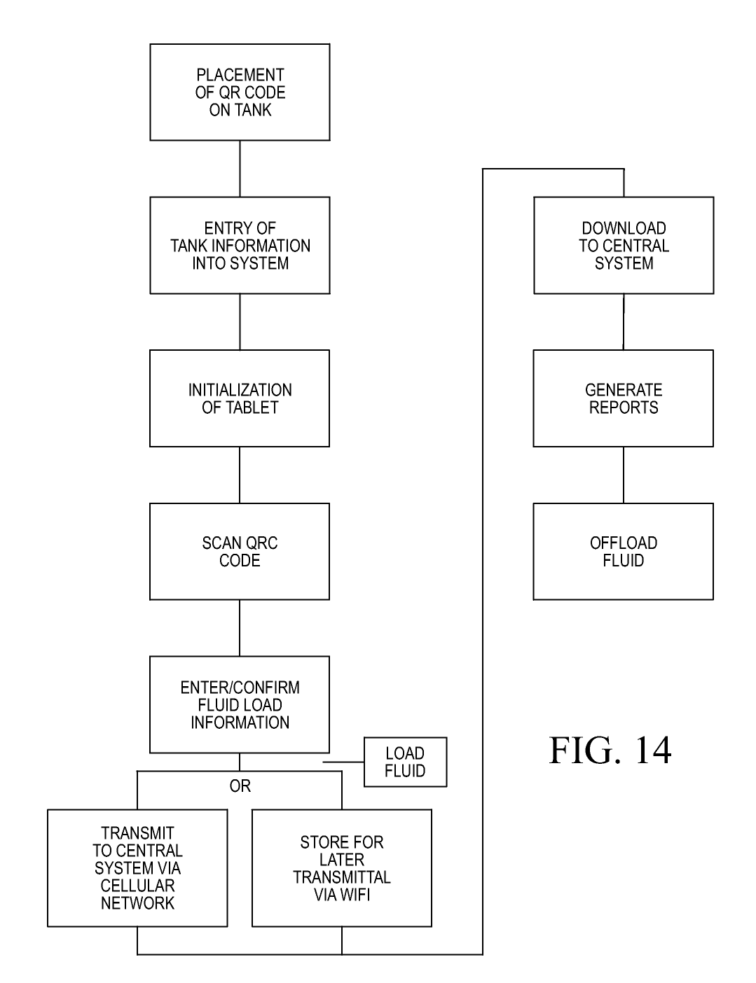

Upon the start of a work shift, the driver will be assigned a portable computing device or tablet device with a suitable application, according to the teachings of the present invention, installed on it. With reference to FIGS. 2 and 14, using this application on the tablet device 30, preferably on an operating system such as Android having a user interface such as a touch screen, the driver will initiate the system, for example by pressing a “button,” which may be a “start shift” button 31. From there the driver will select or confirm identifying information, typically his or her name and fluid transporter (truck) number. After confirming this information (which may be by touching a “confirm” button 32 on the touch pad, see FIG. 3), the system then initiates billing to the customer (which may be an oil and gas producing company, trucking company, etc.).

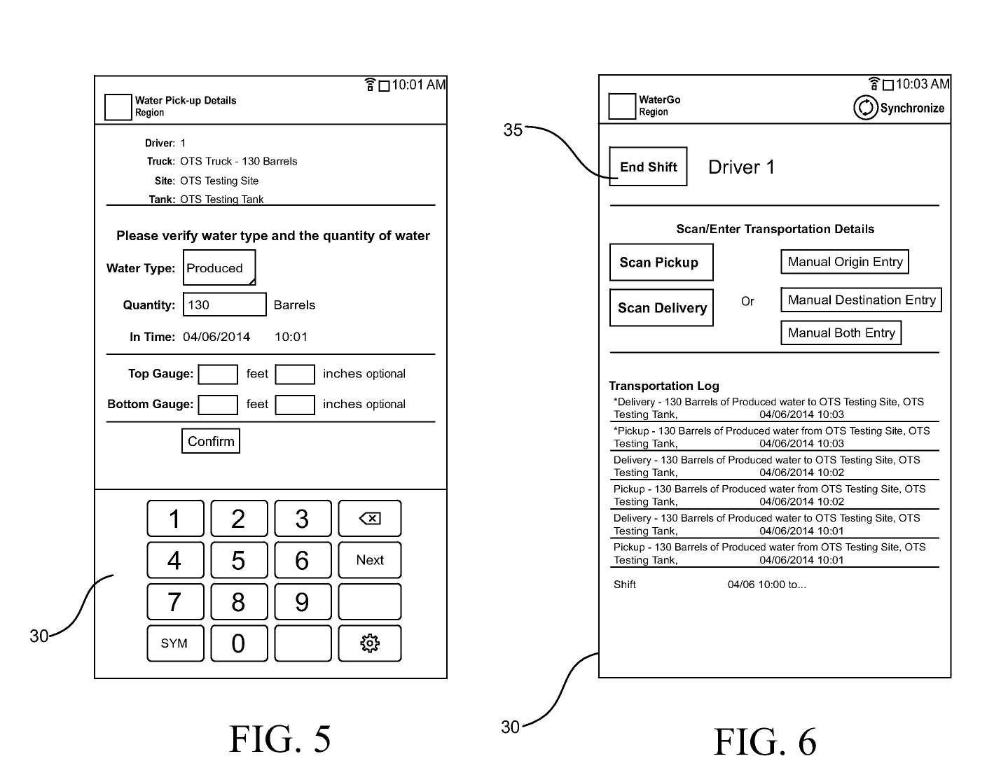

After arriving at the site of the fluid pick up, the driver will position the fluid transporter or truck 40 into an operative relationship with tank 10, as can be seen in FIG. 6, and transfer a load of fluid (typically by hoses, pumps, etc. as known in the art), for example produced water or produced crude oil, into tank truck 40. Once truck 40 is loaded the driver will then press an appropriate input button on the portable computing device or tablet 30 to signify to the system that a load has been taken on, for example one labeled “Scan pickup” 33, as can be seen in FIG. 2. The driver will then aim tablet 30 toward QR code 20 on tank 10, so that QR code 20 is seen in on the screen of tablet 30 and can be detected by the optical reader on tablet 30. The optical reader receives relevant information from QR code 20 and enters it into the system. FIGS. 4 and 5 are illustrative of these steps.

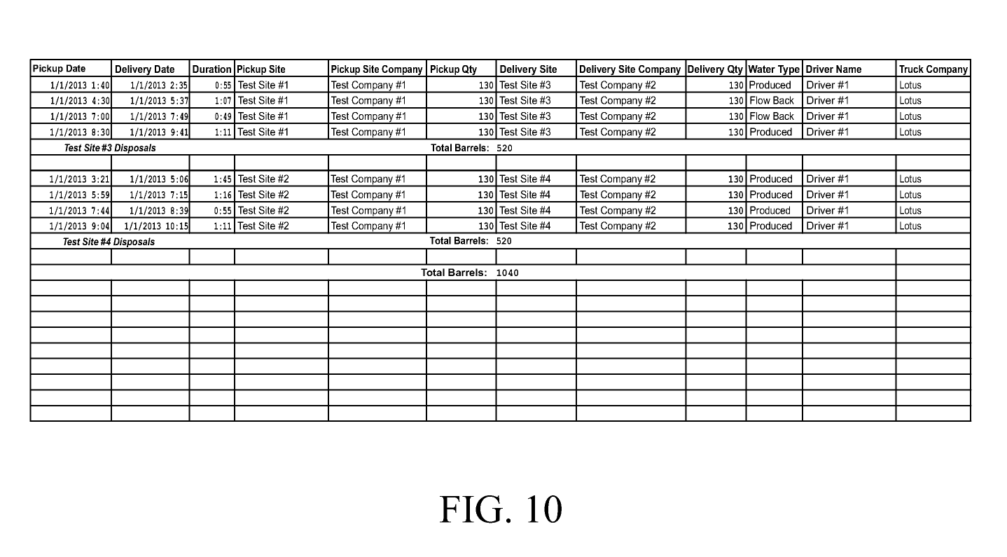

Once the QR code is read, another appropriate screen, for example the “pickup screen,” FIG. 5, will appear, showing all the previously encoded information associated with that QR code (including, for example, the particular fluid pickup location). The fluid type information spaces (produced water, flow back water, fresh water, produced crude oil) will be pre-populated with information associated with the particular QR code. Preferably, the possible changes by the driver are limited; by way of example, the system may be set up that the driver can change only the type of fluid being picked u (shown as “Water Type” in FIG. 5), and/or only the fluid volume. The volume of fluid picked up defaults to the full capacity of the truck or other fluid transporter 40. If the driver does not transfer a full load to fluid transporter 40 (that is, the truck is not completely filled), then the “load volume” or “quantity” value, as can be seen in FIG. 5, can be changed. Top gauge and bottom gauge readings, also seen in FIG. 10, can also be entered if the particular fluid tank must be “gauged” or measured, to determine how much fluid volume was in fact loaded onto the tank truck.

After all relevant and desired information is entered, and/or previously entered information is checked for accuracy, the driver will confirm same, for example by a touch screen button on the display of the portable computing device or tablet reading “Confirm” 34 as seen in FIG. 5. Appropriate programming then transfers the information via the wireless data transfer system to the central system maintained on a digital processor or computer (CPU), see FIGS. 12 and 13, and the fluid pickup will then show on the “transportation log.” FIG. 6 shows a representative screen display of the portable computing device or tablet 30, showing the transportation log.

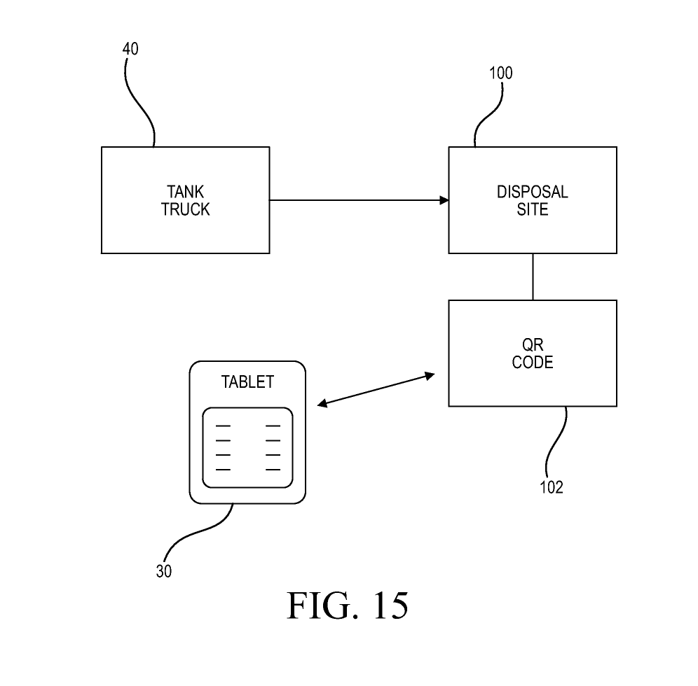

The driver will proceed to the fluid delivery point and transfer the fluid from the fluid transporter into another tank, disposal well, or other site, depending upon the type of fluid. Once the fluid is transferred from the fluid transporter 40, the driver will then scan the QR code 102 at the delivery location or disposal site 100, again using the optical reader on the portable computing device or tablet 40. FIG. 15 depicts the various equipment and action. It is understood that disposal site 100 may comprise a disposal point such as a disposal well (commonly referred to as a “saltwater disposal well”), pit, or other approved disposal means. The system will transmit relevant data via the wireless data transfer system, the delivery will then show in the “transportation log,” see FIG. 6, and the load will be complete. The driver will then proceed to the next fluid pickup location and follow the same process throughout the duration of their shift. If necessary, drivers can attach comments onto their pickups and deliveries to note important information. At the end of their shift, the driver may signify same by an appropriate touch screen selection on the portable computing device, for example by selecting “End Shift” button 35 on tablet 30, as can be seen on FIG. 6, and the shift will be complete.

If the tablet is only WiFi capable, the data from that shift will then sync automatically to the database once the driver is in range of the WIFI signal, see FIG. 12. If the particular portable computing device, alternatively, is network-enabled (i.e. a “network tablet,” on a cellular network such as AT&T, Verizon, etc.) the data will be syncing the entire shift at relatively short intervals, for example every 30 seconds, as long as the tablet has a cellular network connection. FIG. 13 is representative of this situation.

As noted, FIGS. 12 and 13 depict certain of the hardware associated with an embodiment of the teachings of the present invention, in connection with the wireless data transmission system of the present invention. FIG. 12 shows various objects associated with a WiFi-enabled personal computing device 30 system, namely tank 10, associated QR code 20, personal computing device 30 reading QR code 20; transmitting relevant information to a WiFi receiver 60, and thence to a CPU 70, also known as a digital processor, computer, etc. As described herein, appropriate software and programming associated with CPU 70 enables manipulation of the information into desired report formats, etc. Appropriate applications, software and programming, as may be understood by those having skill in the relevant art, are also associated with personal computing device 30, etc. Similarly, FIG. 13 shows various objects associated with a cellular-network enabled personal computing device 30 system, namely tank 10, associated QR code 20, personal computing device 30 reading QR code 20; transmitting relevant information to a cellular tower 80, and thence to a CPU 70, also known as a digital processor, computer, etc. As described herein, appropriate software and programming associated with CPU 70 enables manipulation of the information into desired report formats, etc. Appropriate applications, software and programming, as may be understood by those having skill in the relevant art, are also associated with personal computing device 30, etc.

The steps of the method(s) of the present invention may be seen in FIG. 14, it being understood that same depicts non-exclusive listing of steps embodying one method according to the principles of the present invention:
placement of a QR code on a tank
entry of tank and related information into the system, stored on the portable computing device and/or the CPU
initialization of tablet (personal computing device)
scanning of the QR code
entering or confirming fluid load information
transmitting fluid load and other relevant information to central system via WiFi, if so enabled, or storing for later transmission via WiFi; or transmitting to central system via cellular network
download relevant information to the central system
generate desired reports using the information

Additional steps may include offloading of the collected fluid at a disposal site, and collection of additional data in association with that action, and transmitting same to the central system.

### Managing the Data

The portable computing devices 30 automatically transmit data (commonly referred to as “sync”) to the server on CPU 70 at frequent intervals, for example every 30 seconds, when connected to WiFi or if there is a cellular network connection on network-enabled tablets. When transmitting, the portable computing device 30 uploads, via the wireless data transfer system, any data that is stored on it (start shifts, pickups, deliveries, end shifts, comments) and downloads (again, via the wireless data transfer system) any new information from the server (new tanks, new sites, new companies, new trucks, new driver etc), as can be understood from FIGS. 12 and 13, therefore insuring that data on portable computing device 30 is up to date.

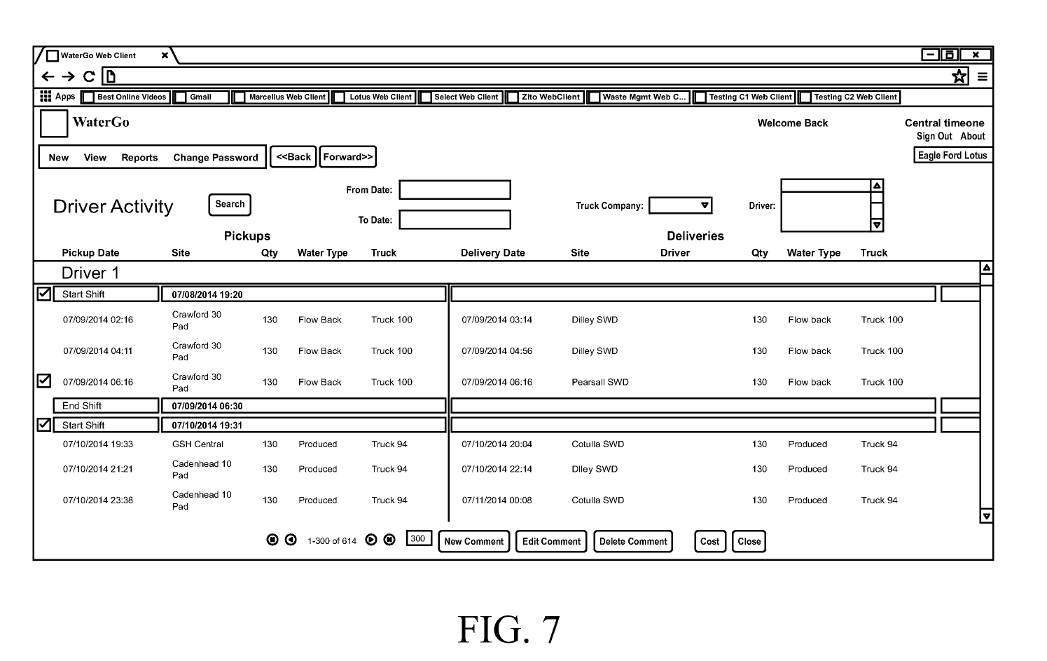

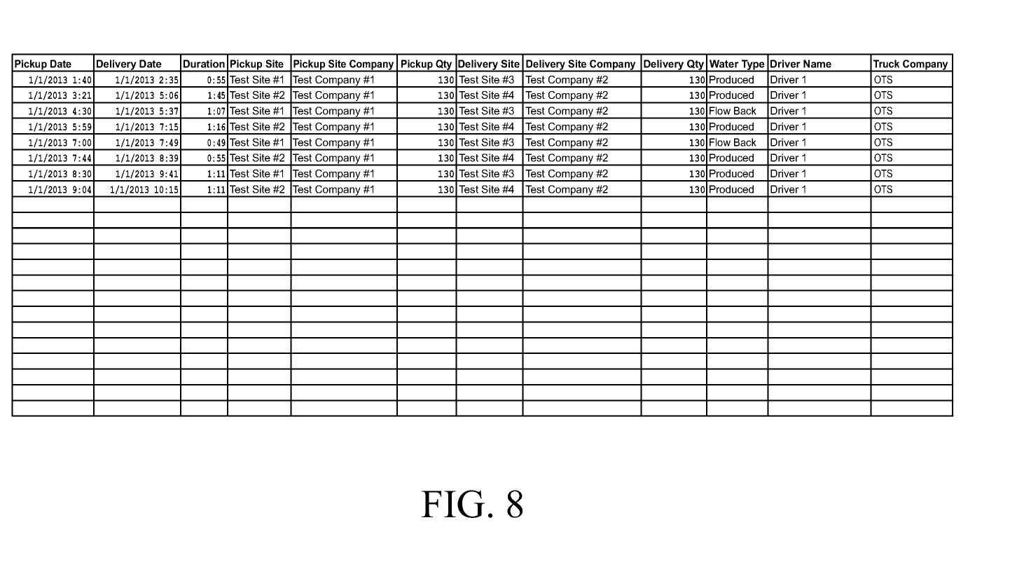

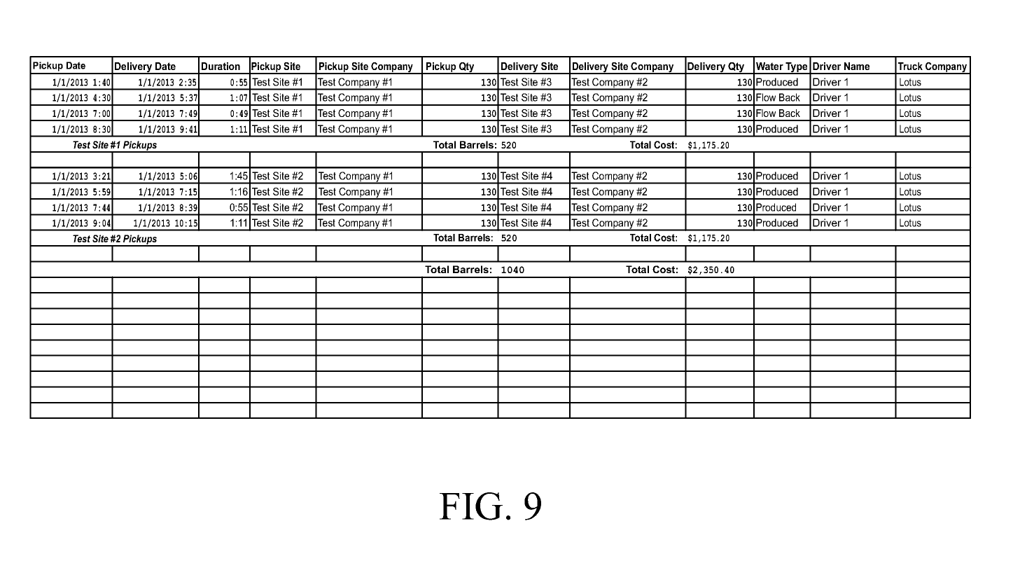

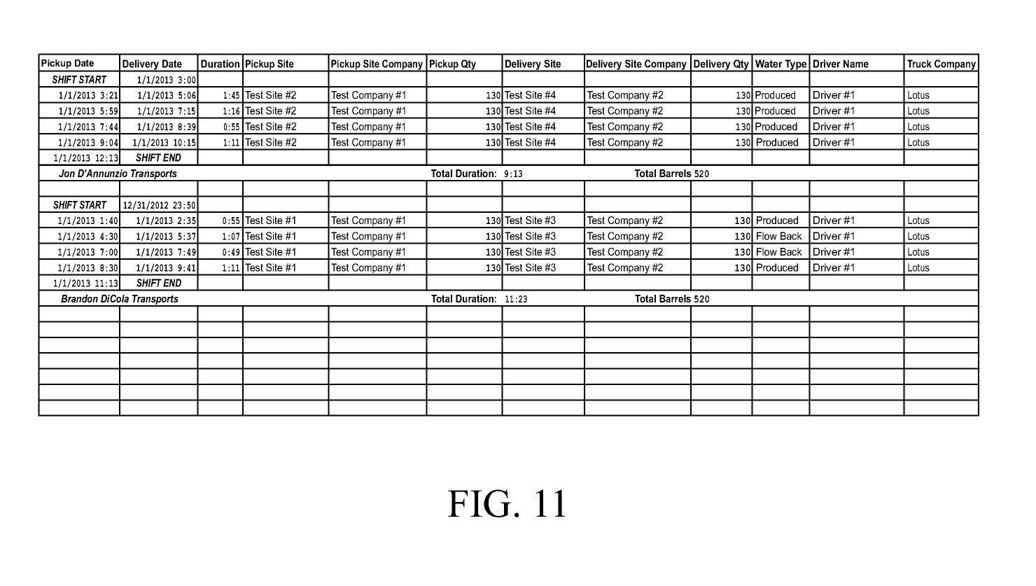

Once the information from personal computing device 30 is uploaded to the server on CPU 70, it is accessed through web based services or programs. Through these web based services, information can be changed, added, deleted, organized and managed to achieve desired goals and ensure accuracy of the operations. Once the data is correct, reports are created via the web based services. These reports can be exported to a csv file or pdf for easy viewing and data management. The reports show drivers activities (start shifts, pickups deliveries, end shifts), they show every load as a line item including unique id (ticket number) pickup date/time, delivery date and time, duration, pickup location, pickup tank, pickup location company, delivery location, delivery tank, delivery company, truck company, truck number, truck drivers name, quantity, type of fluid or waste, and cost. FIGS. 7-11 show exemplary, non-exclusive report formats as follows:
FIG. 7 shows a Driver Activity report, showing activity of a designated driver over a selected time period
FIG. 8 is a daily transport record, showing all transports on a selected day
FIG. 9 is a report showing pickups from a designated location, on a designated day
FIG. 10 is a report showing all disposals at a selected disposal or offload site
FIG. 11 is a report sorted by day and driver

Reports can be customized to show all transportation data together, data sorted by pickup site, delivery site, pickup tank delivery tank, etc. These reports may then used to create invoices and bill an appropriate entity, for example an oil and gas company. Further, if desired, the data can be directly imported into accounting systems or invoices can be generated directly from the data via the web based services.

It is to be understood that the system of the present invention comprises appropriate computer programming, digital processors, wireless/cellular transmitters and receivers, web sites, etc. in order to properly implement and use the system.

### Global Positioning System Capability

If desired, global positioning system or GPS capability can be incorporated into the system and method of the present invention, in order to identify positional information of fluid tanks, fluid transporters en route, and/or fluid disposal sites. GPS capability and associated software, programming, hardware, as known in the art, is graphically represented in FIGS. 12 and 13 as GPS 90.

Materials Other than Fluids

It is to be understood that the system and method of the present invention may be beneficially used in connection with materials other than fluids, by way of example only drill cuttings generated in connection with oil and gas well drilling operations. Such solid or semi-solid materials would be generally handled and tracked in a manner similar to that disclosed herein, in connection with fluids. Therefore, the scope of the present invention encompasses the tracking of materials in addition to fluids.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof. For example, various types of information can be stored in the fluid tank QR codes; different hardware (tablets, digital processors, etc.) can be used to implement the system; the collected data can be presented in a variety of different formats depending upon customer requirements, etc.

Therefore, the scope of the invention is to be determined not by the illustrative examples set forth above, but by the appended claims and their legal equivalents.

I claim:

1. A method for tracking fluids, comprising the steps of:
placing a tag bearing a Quick Response (QR) code on or in proximity to a tank holding a quantity of fluids;
creating a record of information associated with said QR code, said record including capacity of said tank, location of said tank, and typical fluid contained in said tank, and storing said information in a database maintained on a digital processor;
gathering information regarding a fluids transporter and storing same on a portable computing device, said information including identity of personnel operating said fluids transporter and the capacity of said fluids transporter, said personal computing device comprising an optical reading device capable of reading information from a QR code;
transmitting, via a wireless data transmission system, said information associated with said QR code, to said portable computing device;
moving said fluids transporter into operative relationship with said tank, and transferring fluids from said tank to said fluids transporter;
scanning, with said optical reader of said personal computing device, said QR code and associating the information therefrom with said fluids transporter;
entering, via said personal computing device, fluid volume information for said fluids transfer;
transferring, via said wireless data transmission system, information regarding said transfer of said fluid and said fluids transporter, to a database maintained on a digital processor;
arranging said information in a desired format in said database; and
producing a report containing desired data therein.

2. The method of claim 1, wherein said personal computing device comprises a tablet device.

3. The method of claim 1, wherein said wireless data transmission system comprises a cellular network.

4. The method of claim 1, wherein said wireless data transmission system comprises a local area wireless network (WiFi).

5. The method of claim 1, wherein said fluids comprise fluids flowed from an oil and gas well.

6. The method of claim 1, comprising the further steps of:
moving said fluids transporter from the location where said fluids are received, to a disposal location;
transferring said fluids from said fluids transporter to a disposal point, said disposal point having a QR code associated therewith;
scanning, with said optical reader of said personal computing device, said QR code at said disposal point; and
transferring, via said wireless data transmission system, information regarding said transfer of said fluid to said disposal point, to a database maintained on a digital processor.
